(19) United States
(12) Patent Application Publication
(10) Pub. No.: US 2025/0061677 A1
(43) Pub. Date: Feb. 20, 2025

(54) INFORMATION PROCESSING METHOD, INFORMATION PROCESSING SYSTEM, INFORMATION PROCESSING DEVICE, AND RECORDING MEDIUM

(71) Applicant: CASIO COMPUTER CO., LTD., Tokyo (JP)

(72) Inventors: Takaharu ASHIKAGA, Tokyo (JP); Naohiko YASUDA, Tokyo (JP)

(73) Assignee: CASIO COMPUTER CO., LTD., Tokyo (JP)

(21) Appl. No.: 18/802,079

(22) Filed: Aug. 13, 2024

(30) Foreign Application Priority Data
Aug. 15, 2023 (JP) 2023-132208

(51) Int. Cl. G06T 19/20

(52) U.S. Cl. CPC G06T 19/20; G06T 2219/2016

(57) ABSTRACT

Provided is an information processing method performed by a computer of a terminal device including a display unit and an input unit. In the information processing method, an object placed in a virtual space is displayed on a display unit, based on settings related to a display form of the object in the virtual space, and the settings related to the display form of the object are adjusted based on avatar information on an avatar when the avatar satisfying a predetermined condition is located within a reference range including a location of the object in the virtual space.

### REFERENCE OF RELATED APPLICATION

This application claims priority from Japanese Patent Application No. 2023-132208, filed Aug. 15, 2023, and incorporates by reference the entire specification, claims, abstract, and drawings of Japanese Patent Application No. 2023-132208.

### TECHNICAL FIELD

This disclosure relates to an information processing method, an information processing system, an information processing device, and a recording medium.

### BACKGROUND

Conventionally, Japanese Unexamined Patent Application Publication No. 2016-152521 describes a service that enables users to operate avatars in response to user operations in a virtual space constructed by a computer, to communicate with other users who are operating other avatars, and to participate in events and games held in the virtual space. In addition to avatars, various objects with predefined display forms are placed in the virtual space.

### SUMMARY

To solve the above problem, an information processing method according to this disclosure is provided. The information processing method performed by a computer, wherein the computer adjusts settings related to a display form of an object in a virtual space, based on avatar information on an avatar, when the avatar satisfying a predetermined condition is located within a reference range including a location of the object in the virtual space in which the object is placed.

### BRIEF DESCRIPTION OF DRAWINGS

FIG. 1 is a diagram illustrating a configuration of an information processing system.

FIG. 2 is a block diagram illustrating a functional configuration of a server.

FIG. 3 is a diagram illustrating an example of avatar data contents.

FIG. 4 is a diagram illustrating an example of object data contents.

FIG. 5 is a diagram illustrating an example of variation data contents.

FIG. 6 is a block diagram illustrating a functional configuration of a control device.

FIG. 7 is a block diagram illustrating a functional configuration of a VR device.

FIG. 8 is a diagram illustrating a VR screen.

FIG. 9 is a diagram illustrating a VR screen with other avatars displayed.

FIG. 10 is a diagram for describing an operation of adjusting the orientation of a watch object.

FIG. 11 is a diagram for describing an operation of adjusting the orientation of the watch object when a plurality of avatars is present.

FIG. 12 is a diagram illustrating a VR screen when the avatar in operation is within the reference range.

FIG. 13 is a diagram illustrating a VR screen when the avatar activates the virtual camera application in the state of FIG. 12.

FIG. 14 is a diagram for describing how to switch between a global display mode and a local display mode.

FIGS. 15A to 15C are diagrams illustrating an example of adjusting the display form in the global display mode.

FIGS. 16A to 16C are diagrams illustrating an example of adjusting the display form in the local display mode.

FIG. 17 is a flowchart illustrating a control procedure for object display processing.

FIG. 18 is a flowchart illustrating a control procedure for target avatar condition determination processing.

FIG. 19 is a flowchart illustrating a control procedure for display setting adjustment processing.

### DETAILED DESCRIPTION OF EMBODIMENTS

Hereinafter, the embodiments of this disclosure are described based on drawings.

(Overview of information processing system)

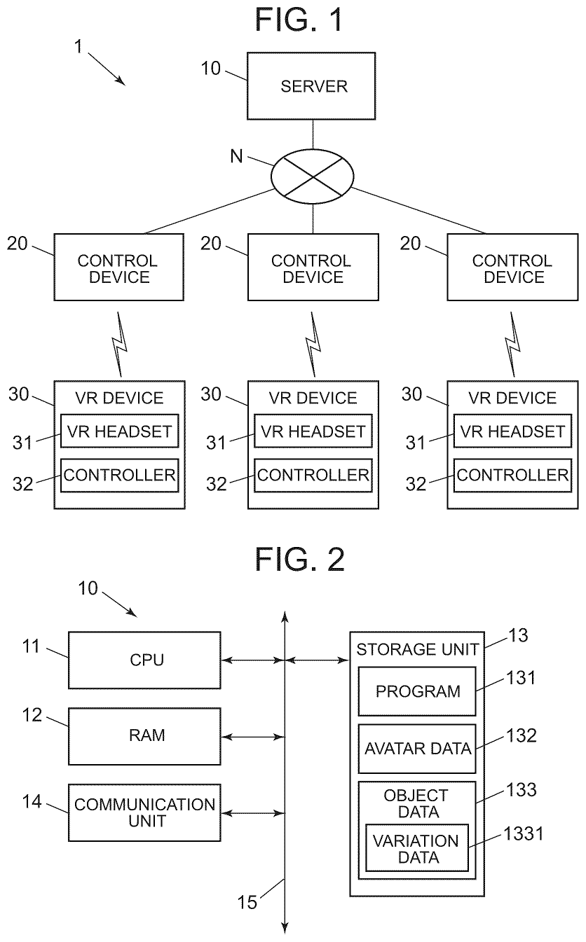

FIG. 1 is a diagram illustrating a configuration of an information processing system 1.

The information processing system 1 includes a server 10 (information processing device), a plurality of control devices 20, and a plurality of VR devices 30 (terminal devices). The information processing system 1 provides various services in a three-dimensional virtual space (metaverse) constructed by computers to a plurality of users of the information processing system 1. The information processing system 1 is also capable of providing users with services that apply virtual reality (VR) in the metaverse (hereinafter, referred to as “VR services”). VR is a technology that allows users to experience a virtual world constructed in a virtual space as if it were reality.

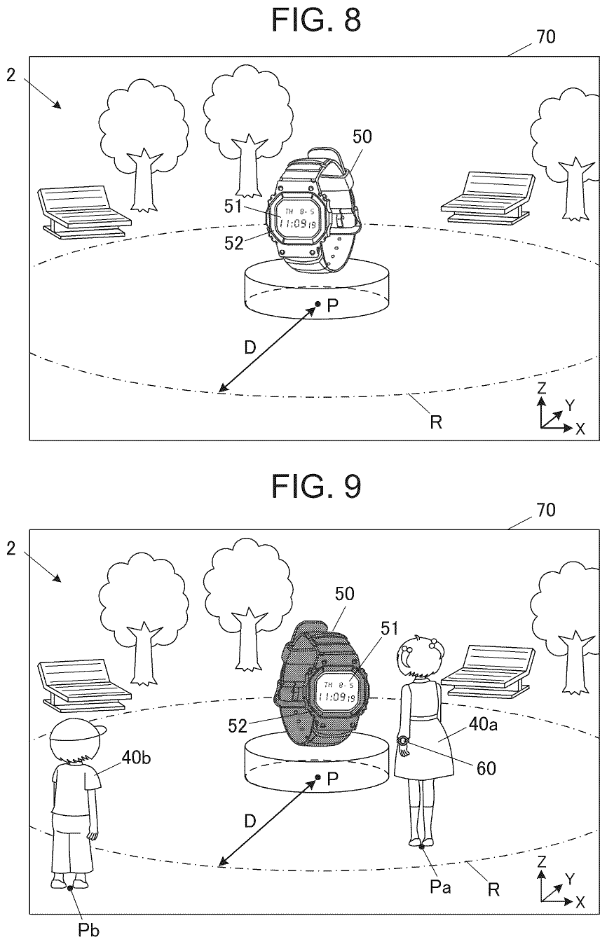

Each user of the information processing system 1 uses one control device 20 and one VR device 30. The control device 20 and the VR device 30 are connected to each other in such a way as to be able to transmit and receive data via wireless communication. The VR device 30 includes a VR headset 31 (a head-mounted device) and a controller 32, which are worn by the user when used. The VR device 30 detects user motions and input operations with the VR headset 31 and the controller 32, and transmits the detection results to the control device 20. The control device 20 transmits data such as a VR image 70 (see FIGS. 8 and 9, or the like) and sound of the virtual space 2 to the VR headset 31 in response to a user motion and an input operation detected by the VR device 30, and causes the VR image 70 to be displayed and the sound to be output. In this way, VR is implemented by displaying the VR image 70 in the virtual space 2 on the VR headset 31 in real time in response to the user motion and the input operation and by outputting the sound. In the virtual space 2, a character called “avatar 40” (for example, avatars 40a and 40b in FIG. 9. Hereinafter, “avatar 40” is used to refer to arbitrary one avatar) behaves on behalf of the user. In other words, the VR image 70 in the virtual space 2 viewed from the viewpoint of the avatar 40 is projected on the VR headset 31 in real time. It is assumed that the positions of the avatar 40 and various objects in the virtual space 2 are represented by the XYZ Cartesian coordinate system.

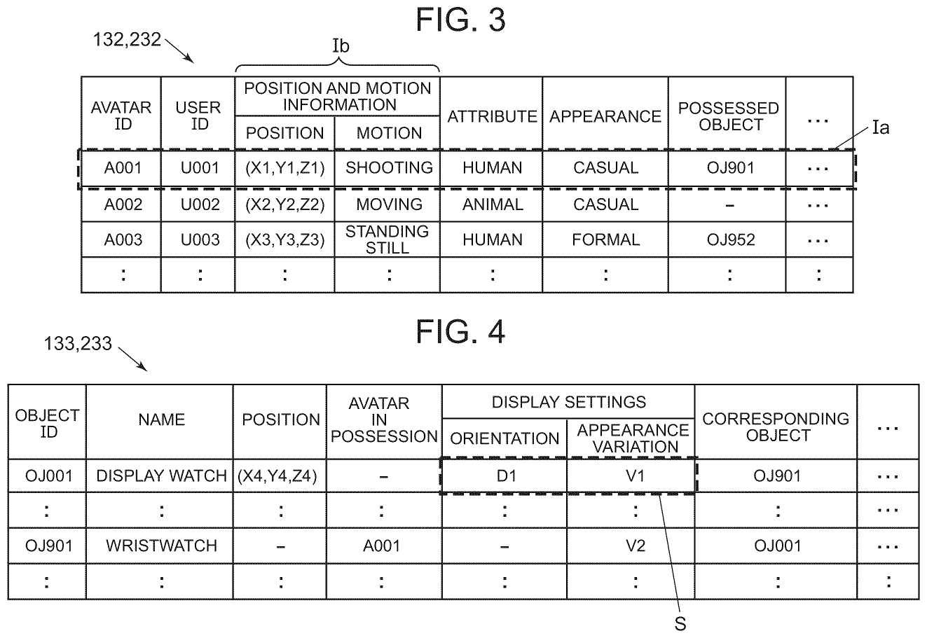

The plurality of control devices 20 are connected to the server 10 via a network N in such a way as to transmit and receive data to and from the server 10. The network N is, for example, the Internet, but not limited thereto. The server 10 acquires and manages various data necessary for providing VR services, and transmits the various data to the plurality of control devices 20 as needed. For example, the server 10 receives and aggregates position and motion information Ib (see FIG. 3: information on the real-time position and motion of the avatars 40 in response to user operations) of the avatars 40 of respective users from the plurality of control devices 20, and transmits the position and motion information or the like to the respective control devices 20.

The following is a detailed description of components of the information processing system 1.

(Configuration of server)

FIG. 2 is a block diagram illustrating the functional configuration of the server 10.

The server 10 includes a central processing unit (CPU) 11 (a processing unit, a computer), a random access memory (RAM) 12, a storage unit 13, a communication unit 14, and a bus 15. Respective parts of the server 10 are connected to each other via the bus 15. The server 10 may further include an operation unit, a display unit, and so on, which are used by the administrator of the server 10.

The CPU 11 is a processor that reads and executes a program 131 stored in the storage unit 13 and performs various arithmetic operations to control the operation of each part of the server 10. The server 10 may have a plurality of processors (for example, a plurality of CPUs), and a plurality of processes performed by the CPU 11 in this embodiment may be performed by the plurality of processors. In this case, the “processing unit” is composed of the plurality of processors. In this case, the plurality of processors may be involved in a common process, or the plurality of processors may independently perform different processes in parallel.

The RAM 12 provides the CPU 11 with a working memory space to store temporary data.

The storage unit 13, which is a non-temporary recording medium readable by the CPU 11 as a computer, stores the program 131 and various data. The storage unit 13 includes non-volatile memory such as a hard disk drive (HDD), a solid state drive (SSD). The program 131 is stored in the storage unit 13 in the form of a computer-readable program code. The data stored in the storage unit 13 is avatar data 132, object data 133, or the like. The object data 133 thereof includes variation data 1331.

FIG. 3 is a diagram illustrating an example of the contents of the avatar data 132.

The avatar data 132 includes information (avatar information Ia) related to a plurality of avatars 40 corresponding to a plurality of users of the information processing system 1. One row of data in the avatar data 132 corresponds to the avatar information Ia of one avatar 40. The avatar information la includes data of items such as “avatar ID,” “user ID,” “position and motion information,” “attribute,” “appearance,” and “possessed object.”

The “avatar ID” is a unique code assigned to the avatar 40.

The “user ID” is a unique code assigned to the user corresponding to the avatar 40.

The “position and motion Information” includes the sub-items of “position” and “motion.” In the following, the part of the avatar data 132 corresponding to the “position and motion information” is also referred to as “position and motion information Ib.”

The “position” represents the positional coordinates of the avatar 40 in the virtual space 2.

The “motion” represents the motion of the avatar 40. This motion includes, for example, “moving” to move in the virtual space 2, “standing still” to stand still in the virtual space 2, and “shooting” to take a picture of the virtual space 2 using a virtual camera application. These, however, are merely illustrative, and “motion” is not limited to those in FIG. 3.

The “attribute” represents the attribute of the avatar 40. In FIG. 3, “human” and “animal” are each illustrated as “attribute.” The “attribute,” however, is not limited to these, and may be an arbitrary element that classifies the avatar 40 such as, for example, a group to which the avatar 40 belongs. The “attribute” may also include a user attribute (for example, an age, a gender, a place of residence, or the like) corresponding to the avatar 40.

The “appearance” represents the characteristics of the appearance of the avatar 40. For example, the “appearance” represents the characteristics of the outfit worn by the avatar 40. In FIG. 3, “casual” representing a casual outfit and “formal” representing a formal outfit are illustrated as examples of “appearance.” The “appearance,” however, is not limited thereto, and may be an arbitrary element that represents the characteristics of the appearance of the avatar 40.

The “possessed object” represents the object ID of an object possessed by the avatar 40. In this embodiment, a wristwatch object 60 (see FIG. 9) is illustrated as an object possessed by the avatar 40. The wristwatch object 60 is able to be worn on the wrist of the avatar 40. When the avatar 40 wearing the wristwatch object 60 behaves in the virtual space 2, the position and orientation of the wristwatch object 60 in the virtual space 2 follow the position and orientation of the wrist of the avatar 40. The state in which the avatar 40 possesses an object is not limited to the state in which the object is worn, but also includes the state in which the object is held without being worn.

The avatar data 132 may contain information other than the information illustrated in FIG. 3.

FIG. 4 is a diagram illustrating an example of the content of the object data 133.

The object data 133 contains information on various objects placed and displayed in the virtual space 2. One row of data in the object data 133 corresponds to one object. Each row of data contains data of items such as “object ID,” “name,” “position,” “avatar in possession,” “display settings,” “corresponding object.”

The “object ID” is a unique code assigned to an object. In FIG. 4, the data of two objects whose object IDs are “OJ001” and “OJ901” are illustrated as examples. Among them, it is assumed that the object with the object ID “OJ001” is a watch object 50 (see FIG. 8) as a display watch, and the object with the object ID “OJ901” is a wristwatch object 60 to be worn by the avatar 40.

The “name” is the name of an object.

The “position” represents the positional coordinates of the object in the virtual space 2. The “position” is set for an object directly placed (installed) in the virtual space 2. In FIG. 4, the position (X4, Y4, Z4) of the watch object 50 with the object ID “OJ001” is set.

The “avatar in possession” represents the avatar ID of the avatar 40 who possesses the object. In FIG. 4, the wristwatch object 60 with the object ID “OJ901” is possessed by the avatar 40 with an avatar ID “A001.”

The “display settings” are the settings according to the display form of an object in the virtual space 2, including data of the sub-items of “orientation” and “appearance variation.”

In the following, the “display settings” of the watch object 50 are referred to as “display settings S.”

The “orientation” represents the orientation of the object in the virtual space 2. The “orientation” may be one representing an azimuth angle in the XY plane, or representing an azimuth angle and an elevation angle in the XYZ space. The “orientation” is set for an object placed (installed) directly in the virtual space 2. In FIG. 4, the orientation of the watch object 50 with the object ID “OJ001” is set to “D1.” The “D1” is assumed to represent a predetermined azimuth angle.

The “appearance variation” is a code that represents one appearance variation among multiple types of appearance variations (appearances) different from each other that have been registered for the object in advance. The object is displayed in the virtual space 2 so that the object has the appearance indicated by the code set in the “appearance variation.” The specific appearance settings corresponding to each code of the “appearance variation” are registered in the variation data 1331 included in the object data 133.

The “corresponding object” is an object ID of another object that has been registered in advance as corresponding to the object in the data row. In the example illustrated in FIG. 4, the wristwatch object 60 with the object ID “OJ901” is registered as a corresponding object to the watch object 50 with the object ID “OJ001.” A plurality of corresponding objects may be registered for one object. The corresponding object is used to determine whether the target avatar condition described later is satisfied.

In the object data 133 illustrated in FIG. 4, the rows of data for the watch object 50 and for the wristwatch object 60 are illustrated as examples, but the object data 133 also contains rows of data for various other objects that are allowed to be components of the virtual space 2. For example, the object data 133 contains data of objects allowed to be components of facilities (parks, event sites, or the like) in the virtual space 2.

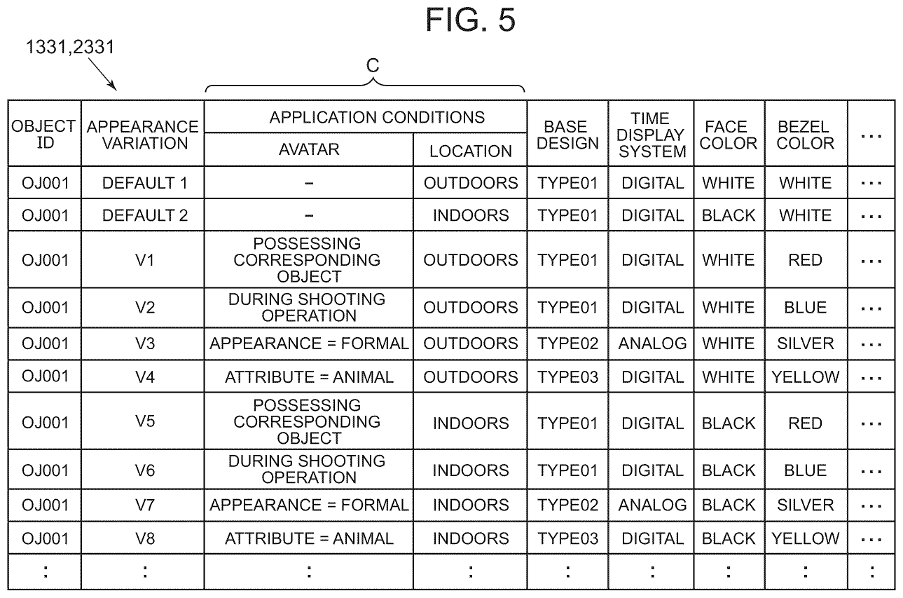

FIG. 5 is a diagram illustrating an example of the contents of the variation data 1331.

One row of data in the variation data 1331 corresponds to one appearance variation of an object. Each row of data contains data of items such as “object ID,” “appearance variation,” “application condition,” “base design,” “time display system,” “face color,” “bezel color,” and so on.

The “object ID” represents the object ID of the object for which the appearance variation in the row of data is registered.

The “appearance variation” is a code assigned to the appearance variation in the row of data. In FIG. 5, for the watch object 50 whose object ID is “OJ001,” ten types of appearance variations such as “default 1,” “default 2,” and “V1” to “V8” are registered. The “application condition” represents the conditions to which the appearance variations in the row of data are applied. The “application condition” includes the sub-item data of “avatar” and “location.” The “avatar” represents the condition for the avatar 40 present within the reference range R (see FIGS. 8 and 9, and the like) described later. The “location” represents the condition related to the location of the object. In the following, the part of the variation data 1331 that corresponds to the “application condition” is also referred to as “application condition C.” The details of the “application condition C” are described later.

The “base design” represents the type of design on which the appearance variation is based. The specific contents of the base design are not particularly limited, but may include, for example, the definition of the shape of each part of the object.

The “time display system” represents whether the time is displayed by the watch object 50 in a “digital” or “analog” style.

The “face color” represents the color setting of the watch face 51 (see FIG. 8) of the watch object 50 in the appearance variation.

The “bezel color” represents the color setting of a bezel 52 (see FIG. 8) of the watch object 50 in the appearance variation.

The variation data 1331 may include information other than the information illustrated in FIG. 5. For example, the variation data 1331 may include settings for colors of parts other than the watch face 51 and the bezel 52. The variation data 1331 may also include settings for the shape, pattern, and the like of each part. In addition, the variation data 1331 may include file paths and the like of 3D model data of an object (or parts of the object).

Returning to FIG. 2, the communication unit 14 performs a communication operation according to a predefined communications standard. With this communication operation, the communication unit 14 transmits and receives data to and from the control device 20 via the network N.

(Configuration of controller)

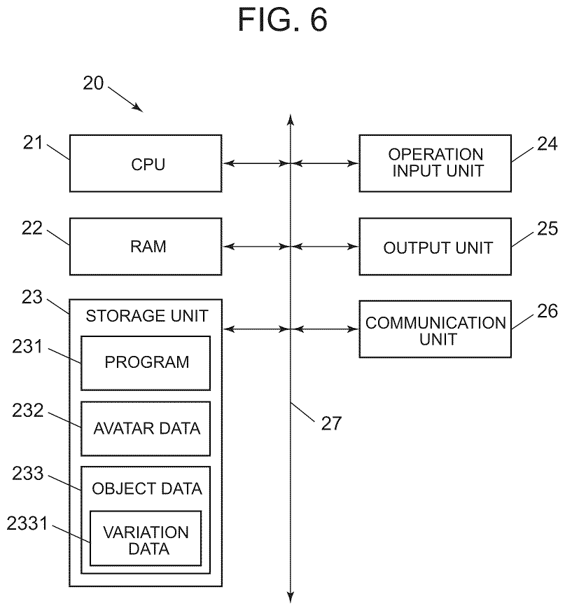

FIG. 6 is a block diagram illustrating a functional configuration of the control device 20.

The control device 20 includes a CPU 21, a RAM 22, a storage unit 23, an operation input unit 24, an output unit 25, a communication unit 26, and a bus 27. The parts of the control device 20 are connected to each other via the bus 27. The control device 20 is, for example, a laptop PC or a stationary PC, but not limited thereto and may also be a tablet terminal or a smart phone.

The CPU 21 is a processor that reads and executes a program 231 stored in the storage unit 23, and controls the operations of the respective parts of the control device 20 by performing various arithmetic operations. Note that the control device 20 may have a plurality of processors (for example, a plurality of CPUs), and a plurality of processes performed by the CPU 21 in this embodiment may be performed by the plurality of processors. In this case, the plurality of processors may be involved in a common process, or the plurality of processors may independently perform different processes in parallel.

The RAM 22 provides the CPU 21 with a working memory space to store temporary data.

The storage unit 23 is a non-transient recording medium readable by the CPU 21 as a computer and stores programs such as the program 231 and the like and various data. The storage unit 23 includes non-volatile memories such as an HDD, an SSD, and the like. The programs are stored in the storage unit 23 in the form of computer-readable program codes. The data stored in the storage unit 23 include avatar data 232 and object data 233. The object data 233 includes variation data 2331. The avatar data 232 and the object data 233 are data received from the server 10 and stored in the storage unit 23. The avatar data 232 includes the same data as at least a part of the avatar data 132 of the server 10. The object data 233 and the variation data 2331 include the same data as at least a part of the object data 133 and variation data 1331 of the server 10, respectively. In this embodiment, as illustrated in FIGS. 3 to 5, the avatar data 232, the object data 233, and the variation data 2331 are assumed to be identical to the avatar data 132, the object data 133, and the variation data 1331, respectively.

The operation input unit 24 accepts input operations by a user and outputs input signals to the CPU 21 according to the input operations. The operation input unit 24 includes input devices such as, for example, a keyboard, a mouse, and a touch panel.

The output unit 25 outputs information to the user, such as information on processing contents and various statuses of the control device 20. The output unit 25 includes, for example, a display device such as a liquid crystal display, a sound output device such as a speaker, and a light emitting device such as an LED.

The communication unit 26 performs a communication operation according to a pre-defined communications standard. The communication unit 26 transmits and receives data to and from the server 10 via the network N using this communication operation. The communication unit 26 also transmits and receives data to and from the VR device 30 via wireless communication.

(Configuration of VR device)

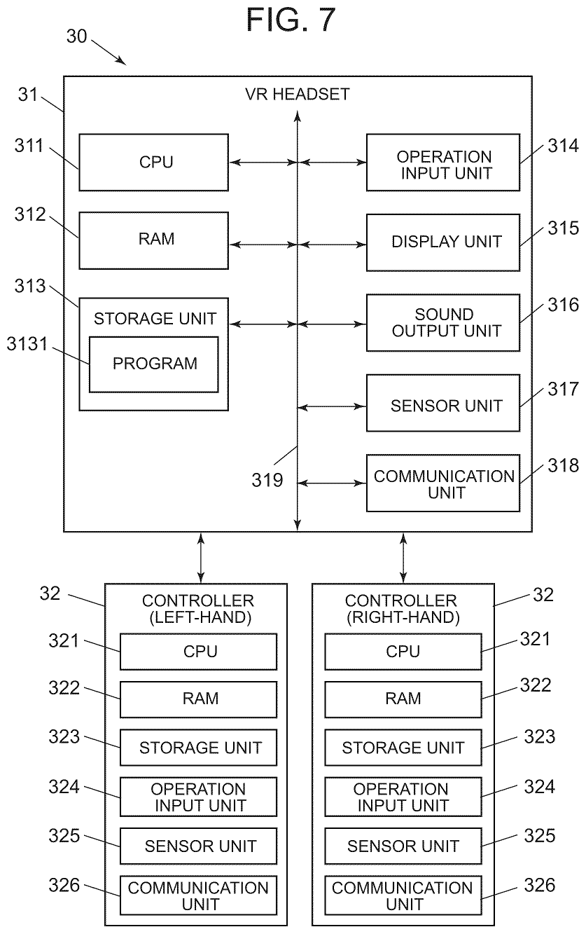

FIG. 7 is a block diagram illustrating a functional configuration of the VR device 30.

The VR device 30 includes a VR headset 31, a right-hand controller 32, and a left-hand controller 32. The two controllers 32 are connected to the VR headset 31 by wireless or wired connection so as to be able to perform data communication. The VR headset 31 is worn on the user's head when used. The controller 32 is worn or held in the user's hand when used. The controller 32 corresponds to an “input unit.”

The VR headset 31 includes a CPU 311, a RAM 312, a storage unit 313, an operation input unit 314, a display unit 315, a sound output unit 316, a sensor unit 317, a communication unit 318, a bus 319, and the like. The parts of the VR headset 31 are connected to each other via the bus 319.

The CPU 311 is a processor that reads and executes a program 3131 stored in the storage unit 313, and controls the operations of the respective parts of the VR headset 31 by performing various arithmetic operations. The VR headset 31 may have a plurality of processors (for example, a plurality of CPUs), and the plurality of processes performed by the CPU 311 in this embodiment may be performed by the plurality of processors. In this case, the plurality of processors may be involved in a common process, or the plurality of processors may independently perform different processes in parallel.

The RAM 312 provides the CPU 311 with a working memory space to store temporary data.

The storage unit 313 is a non-transient recording medium readable by the CPU 311 as a computer and stores the program 3131 and various data. The storage unit 313 includes a non-volatile memory such as, for example, a flash memory. The program 3131 is stored in the storage unit 313 in the form of a computer-readable program code.

The operation input unit 314, which includes various switches, buttons, and the like, accepts user's input operations and outputs input signals to the CPU 311 according to the input operations. The operation input unit 314 may also include a microphone and may be capable of accepting voice input operations from the user using the microphone. The operation input unit 314 corresponds to an “input unit.”

The display unit 315 displays images that are viewed by a user wearing the VR headset 31. The display unit 315 includes a liquid crystal display, an organic EL display, or the like, which is installed in a position visible to a user wearing the VR headset 31. The image data of the image displayed by the display unit 315 is transmitted from the control device 20 to the VR headset 31. The display unit 315 displays images on the basis of the above received image data according to the control by the CPU 311.

The sound output unit 316 outputs various sounds that are recognized by the hearing of the user wearing the VR headset 31. The sound output unit 316 includes a speaker that outputs sounds. The sound data of the sounds output by the sound output unit 316 is transmitted from the control device 20 to the VR headset 31. The sound output unit 316 outputs sound on the basis of the above received sound data according to the control by the CPU 311.

The sensor unit 317 detects the head movement and orientation of the user wearing the VR headset 31. The sensor unit 317 includes, for example, a 3-axis acceleration sensor that detects acceleration in three orthogonal axis directions, a 3-axis gyro sensor that detects an angular velocity around three orthogonal axis directions, and a 3-axis geomagnetic sensor that detects geomagnetism in three orthogonal axis directions. The CPU 311 derives the user's head movement and orientation on the basis of the acceleration data, angular velocity data, and geomagnetic data received from the sensor unit 317. The sensor unit 317 is capable of accepting the user's movement and orientation as user operations, and corresponds to an “input unit.”

The communication unit 318 performs a communication operation according to a predefined communications standard. The communication unit 318 performs this communication operation to transmit and receive data via wireless communication with the controller 32 and the control device 20.

The controller 32 includes a CPU 321 that controls the operations of the controller 32 as a whole, a RAM 322 that provides the CPU 321 with a working memory space, a storage unit 323 that stores programs and data or the like necessary for execution of the programs, an operation input unit 324, a sensor unit 325, and a communication unit 326 that performs data communication with the VR headset 31.

The operation input unit 324 (input unit) has various switches, buttons, operation keys and the like to accept user's input operations and to output input signals to the CPU 321 according to the input operations. The operation input unit 324 may be capable of detecting the movement of each finger of the user separately.

The sensor unit 325 includes a 3-axis acceleration sensor, a 3-axis gyro sensor, and a 3-axis geomagnetic sensor to detect the hand movement and orientation of the user holding or wearing the controller 32. The configuration and operation of the sensor unit 325 may be the same as those of the sensor unit 317 of the VR headset 31, for example.

The configuration of the VR device 30 is not limited to the above.

For example, the VR device 30 may further include an auxiliary sensor device that is not held or worn by the user. This sensor device may be, for example, a device that is installed on a floor or the like and optically detects the user's movements or the movements of the VR headset 31 and the controller 32 by laser scanning or the like.

In the case where there is no need to detect the movements of both hands separately or the like, one of the controllers 32 may be omitted. In the case where the VR headset 31 is able to detect necessary user motion and input operations, the controller 32 may be omitted.

(Basic operations of information processing system)

The following describes the basic operations of an information processing system 1.

In the following description, the operating entities are the CPU 11 of the server 10, the CPU 21 of the control device 20, the CPU 311 of the VR headset 31, or the CPU 321 of the controller 32. For convenience of description, however, the server 10, the control device 20, the VR headset 31, or the controller 32 may be described as an operating entity in some cases.

The user's movements and input operations detected by the VR device 30 are hereinafter collectively referred to as “user operations.” In other words, it is assumed that the “user operation” in this embodiment includes input operations detected by the operation input unit 314 of the VR headset 31 and the operation input unit 324 of the controller 32, and operations detected by the sensor unit 317 of the VR headset 31 and the sensor unit 325 of the controller 32.

In the following description, the image display operation in the VR headset 31 is focused on, and the description of other operations such as sound output is omitted.

When a user starts using the VR service provided by the information processing system 1, the user wears the VR headset 31 and the controller 32 of the VR device 30, and performs a predetermined operation for starting the VR service. When the user authentication information is transmitted from the control device 20 to the server 10 in response to the operation and the user is authenticated by the server 10, the authentication result is returned from the server 10 to the control device 20 and then the provision of the VR service is started for the authenticated user.

When the VR service starts, the control device 20 downloads necessary avatar data 232 and object data 233 from the server 10 and stores the object data 233 in the storage unit 23. In addition, the control device 20 starts transmitting image data of the virtual space 2 to the VR headset 31 of the VR device 30. In this specification, the position of the user's avatar 40 in the virtual space 2 is set in the predetermined initial position, and the image data of the virtual space 2 viewed from the viewpoint of the avatar 40 present in the initial position is transmitted to the VR headset 31. The image data is generated based on the avatar data 232, the object data 233, and the like. In response to the transmission of the image data, the display unit 315 of the VR headset 31 starts displaying a VR screen 70 of the virtual space 2 on the basis of the received image data.

FIG. 8 is a diagram illustrating the VR screen 70.

The VR screen 70 illustrated in FIG. 8 is a three-dimensional image of a park provided in the virtual space 2, as seen from the viewpoint of the avatar 40 (hereinafter, referred to as “avatar 40 in operation”) corresponding to a user in operation. Since the VR screen 70 is displayed from the first-person viewpoint of the avatar 40, the image of the avatar 40 in operation is basically not displayed on the VR screen 70.

Instead of the VR screen 70, a third-person viewpoint screen (not illustrated) viewed from a third-person viewpoint different from the viewpoint of the avatar 40 may be displayed. The third-person viewpoint screen displays the appearance of the avatar 40 in operation. The user may be capable of switching between the VR screen 70 and the third-person viewpoint screen by performing a predetermined operation.

In the park in the virtual space 2 illustrated in FIG. 8, the watch object 50 with the avatar ID “OJ001” is installed on a pedestal. The watch object 50 is a wristwatch-type object for display or advertisement, which has almost the same height as the avatar 40. The location of the watch object 50 in the virtual space 2 is referred to as “object position P.” The object position P is a point on the XY-plane and may be, for example, the center position (center of gravity position) of the watch object 50 when viewed from the +Z direction.

In the object data 233 at the start of the VR service, the “orientation” and the “appearance variation” of the display settings S of the watch object 50 are the contents of the predetermined initial settings. The VR screen 70 displays the watch object 50 with the appearance reflecting these initial settings. The initial setting of the “appearance variation” is “default 1” or “default 2” of the variation data 2331 illustrated in FIG. 5. In FIG. 8, the watch object 50 is placed outdoors, and therefore the “default 1” setting, where the “location” in the application condition C of the variation data 2331 is “outdoors,” is applied. According to the “default 1” setting, the watch object 50 in FIG. 8 has the appearance of a white watch face 51 and a white bezel 52.

When the VR service starts and the VR screen 70 is displayed, the VR device 30 starts detecting the user operation and continuously transmits the detection results to the control device 20. The control device 20 controls the motion of the avatar 40 in the virtual space 2 according to the received user operation. In other words, the control device 20 identifies and updates the position and motion of the avatar 40 in the virtual space 2 in real time, based on the received user operation. The position information of the avatar 40 is assumed to include the orientation and posture information of the avatar 40. The latest identified position and motion are reflected in the position and motion information Ib in the avatar data 232 (the position and motion information Ib is updated to reflect the latest position and motion). Then, the control device 20 generates the image data of the virtual space 2 as seen from the viewpoint of the avatar 40 who is present in the updated position and then transmits the image data to the VR headset 31. The generation and transmission of the image data are repeated at a predetermined frame rate. The display unit 315 of the VR headset 31 displays the VR screen 70 at the above frame rate, based on the received image data of the virtual space 2. As a result, a user wearing the VR headset 31 is able to view the virtual space 2 in real time from the viewpoint of the avatar 40 who moves and behaves in the virtual space 2 according to the user's own operations.

The motion described above is performed on each of the plurality of control devices 20 that are provided with the VR service. Real-time position and motion information Ib for each avatar 40 is transmitted from each of the plurality of the control devices 20 to the server 10. The position and motion information Ib in the avatar data 132 of the server 10 is updated to include the latest position and motion information Ib transmitted from each control device 20. The position and motion information Ib for the plurality of avatars 40 in the avatar data 132 is transmitted to each control device 20 in real time and is reflected in the avatar data 232. By referring to the avatar data 232, each control device 20 is able to identify the positions and motions of other avatars 40. In the case where the positions of other avatars 40 are within the display range of the currently displayed VR screen 70, other avatars 40 are displayed on the VR screen 70.

FIG. 9 is a diagram illustrating the VR screen 70 with other avatars 40a and 40b displayed.

The VR screen 70 in FIG. 9 displays the avatars 40a and 40b different from the avatar 40 in operation. It is assumed that the avatar ID of the avatar 40a among the above avatars is “A001” in the avatar data 232 of FIG. 3 and that the avatar 40a wears a wristwatch object 60 with the object ID “OJ901.” The positions of the avatars 40a and 40b are denoted by avatar positions Pa and Pb, respectively. The avatar positions Pa and Pb are each a point on the XY plane, which may be, for example, the center position (the center of gravity position) of the avatar 40a or 40b when viewed from the +Z direction.

(Operation of adjusting object display form)

In this embodiment, when an avatar 40 that satisfies a predetermined target avatar condition (predetermined condition) is located within the reference range R that includes the object position P in the virtual space 2 where the watch object 50 is placed, the display settings S (settings related to the display form) of the watch object 50 in the virtual space 2 are adjusted based on the avatar information Ia on the avatar 40. For example, when the avatar 40a within the reference range R satisfies the target avatar condition in FIG. 9, the “orientation” and the “appearance variation” of the display settings S for the watch object 50 are adjusted.

In this embodiment, the reference range R is a circle with a radius of a predetermined distance D, centered at the object position P, as illustrated in FIGS. 8 and 9. When the avatar position Pa of the avatar 40a is inside the reference range R, the avatar 40a is determined to be within the reference range R.

In this embodiment, the target avatar condition is satisfied when:
(i) the avatar 40 possesses a corresponding object; or
(ii) the avatar 40 is performing a shooting operation to shoot the virtual space 2.

The following concretely describes the operation of adjusting the display form of the watch object 50 for each of the target avatar conditions (i) and (ii).

< (i) Adjustment operation according to target avatar condition for possessing corresponding object>

In the situation illustrated in FIG. 9, a corresponding object that corresponds to the watch object 50 is the wristwatch object 60 with the object ID “OJ901” as illustrated in the object data 233 in FIG. 4. The corresponding object may be, for example, a wristwatch object 60 manufactured by the same manufacturer as the watch object 50. The corresponding object may also be, instead of the corresponding object itself, a thing that is able to be regarded as substantially identical to the corresponding object, or an object that has substantially the same effect in the virtual space 2. For example, in the case where the avatar 40 possesses specific data (ticket data or the like) provided by the manufacturer of the watch object 50, which has substantially the same effect as the corresponding object, the avatar 40 may be considered to possess the corresponding object.

Since the avatar 40a illustrated in FIG. 9 is wearing the wristwatch object 60, which is the corresponding object, the avatar 40a satisfies the target avatar condition. Since the avatar 40a satisfying the target avatar condition is present within the reference range R, the display settings S of the watch object 50 are adjusted based on the avatar information la of the avatar 40a.

The adjustment operation of the display settings S includes adjustment of the “orientation” of the display settings S.

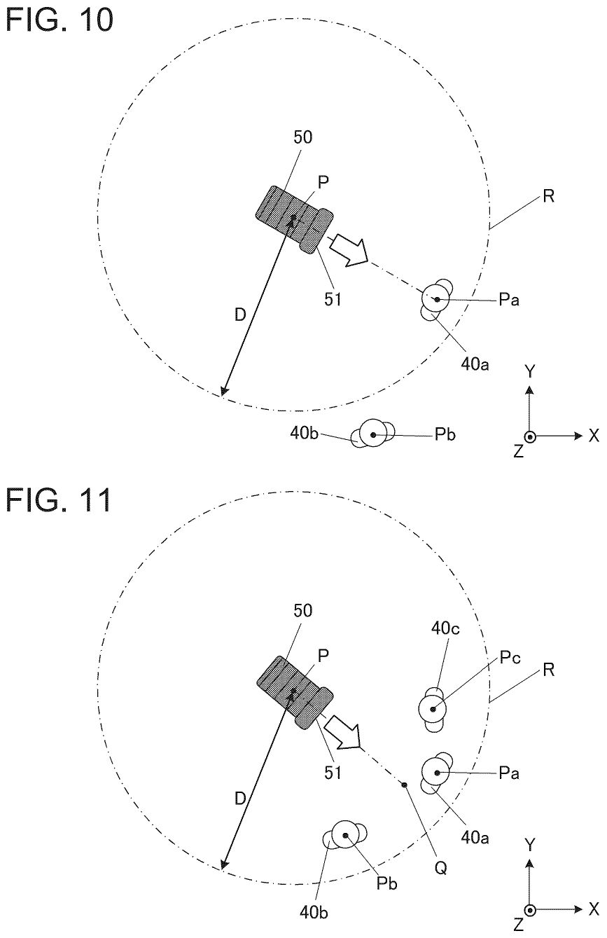

FIG. 10 is a diagram for describing the operation of adjusting the orientation of the watch object 50.

In this embodiment, as illustrated in FIGS. 9 and 10, the “orientation” of the display settings S is adjusted so that the watch face 51 (predetermined region) of the watch object 50 faces the avatar 40a. For example, the “orientation” setting is changed so that the normal direction of the watch face 51 is from the object position P to the avatar position Pa. Since the “orientation” in this embodiment represents an azimuth angle, the watch object 50 is rotated around the Z-axis by changing the “orientation.” As a result, the orientation of the watch object 50 illustrated in FIG. 8 is changed to the orientation of the watch object 50 illustrated in FIG. 9. Note that the azimuth angle and the elevation angle may be changed by the change of the “orientation.” For example, the azimuth angle and the elevation angle of the watch object 50 may be changed so that the watch face 51 faces the face of the avatar 40a.

The adjustment operation of the display settings S includes adjustment (change) of the “appearance variation” of the display settings S. The “appearance variation” is adjusted based on the application condition C of the variation data 2331 illustrated in FIG. 5. Specifically, in the case where the “avatar” condition of the application condition C corresponds to the avatar 40a and the “location” condition of the application condition C corresponds to the location of the watch object 50, with respect to a certain appearance variation among the registered multiple types of appearance variations, the certain appearance variation is selected and reflected in the display settings S. In the example illustrated in FIG. 9, the avatar 40a possesses the corresponding object and the watch object 50 is placed outdoors, and therefore the application condition C of the appearance variation “V1” in FIG. 5 is satisfied. Therefore, the “appearance variation” of the display settings S is changed to “V1” and is reflected in the appearance of the watch object 50. The reflection of the appearance variation “V1” causes a change in the color of the bezel 52 to red for the watch object 50 illustrated in FIG. 9. In addition, the band and other parts are also changed to red according to the settings omitted in FIG. 5. The appearance variation “V1” may be the same model (design) as the corresponding object, the wristwatch object 60. Selecting the appearance variation “V1” corresponds to adjusting the display settings S so that the display form is adjusted according to the possessed object of the avatar 40.

In the case where the priority order of the multiple types of appearance variations is defined in advance, and the application condition C of two or more appearance variations are satisfied, the appearance variation with the highest priority may be selected.

For example, in the case where the appearance variation “V3” has a higher priority than the appearance variation “V1” and the “appearance” of the avatar 40 possessing the corresponding object is “formal,” the appearance variation “V3” is selected, instead of the appearance variation “V1,” and is reflected in the display settings S. Selecting the appearance variation “V3” corresponds to adjusting the display settings S so that the display form is implemented according to the appearance of the avatar 40. For example, when the appearance of the avatar 40 is “formal,” the appearance variation corresponding to a model with a formal design (for example, metallic) may be configured to be selected. In addition, when the appearance of the avatar 40 is “casual,” the appearance variation corresponding to a model with a casual design (for example, resin type) may be configured to be selected. The appearance of the avatar 40 may have the main color of the clothing or exterior thereof. For example, when the avatar 40 is wearing red-colored clothing or exterior, the appearance variation corresponding to the model whose main color is red-colored may be selected. Each of the above models may be a real model.

Moreover, in the case where the priority of the appearance variation “V4” is higher than the appearance variation “V1” and the “attribute” of the avatar 40 possessing the corresponding object is “animal,” the appearance variation “V4” is selected, instead of the appearance variation “V1,” and is reflected in the display settings S. Selecting the appearance variation “V4” corresponds to adjusting the display settings S so that the display form is implemented according to the attribute of the avatar 40.

The following describes an operation performed when a plurality of avatars 40 satisfying the target avatar condition is located within the reference range R.

FIG. 11 is a diagram for describing an operation of adjusting the orientation of the watch object 50 when the plurality of avatars 40 is present.

In FIG. 11, three avatars 40a to 40c satisfying the target avatar condition are located within the reference range R. The positions of the avatars 40a to 40c are assumed to be avatar positions Pa to Pc, respectively. In this case, the “orientation” of the display settings S of the watch object 50 is adjusted so that the watch face 51 of the watch object 50 faces the representative point Q of the plurality of avatars 40a to 40c. The representative point Q may be the average position of the avatar positions Pa to Pc, or may be the midpoint of the avatar positions of the two outermost avatars 40. In this case, the “orientation” setting is changed so that the normal direction of the watch face 51 is from the object position P to the representative point Q. Alternatively, the representative point Q may be a point with a predetermined height in the Z direction. In this case, the “orientation” setting may be changed so that the normal direction of the watch face 51 is toward the representative point Q.

The adjustment of the “appearance variation” of the display settings S is performed based on the avatar information la of the representative avatar decided from among the avatars 40a to 40c that satisfy the target avatar condition, for example. The representative avatar may be, for example, the avatar 40 at the position closest to the object position P or the avatar 40 at the position closest to the representative point Q.

Alternatively, in the case where there is an attribute or appearance common to a majority or all of the avatars 40 among the avatars 40a to 40c that satisfy the target avatar condition, the appearance variation may be selected based on that attribute or appearance. For example, in the case where there are more male avatars 40 than female avatars 40, the appearance variation corresponding to the model for males may be configured to be selected. In the case where there are more female avatars 40 than male avatars 40, the appearance variation corresponding to the model for females may be configured to be selected. In the case where a majority of avatars 40 are wearing red-colored clothing or exteriors, the appearance variation corresponding to the model whose main color is red-colored may be configured to be selected.

When the predetermined restoration condition is satisfied after adjusting the display settings S as described above, the display settings S may be returned to the state before the adjustment. The restoration condition may be, for example, that the avatar 40 satisfying the target avatar condition is no longer in the reference range R. In addition, the restoration condition may be, for example, that the predetermined waiting time has elapsed after the adjustment of the display settings S. The length of the waiting time is not particularly limited, but may be, for example, about five seconds.

< (ii) Adjustment operation according to target avatar condition for shooting operation>

The following describes the target avatar condition for the shooting operation in (ii) described above.

The user is able to activate a virtual camera application to have the avatar 40 shoot the virtual space 2 by performing a predetermined shooting start operation on the VR device 30.

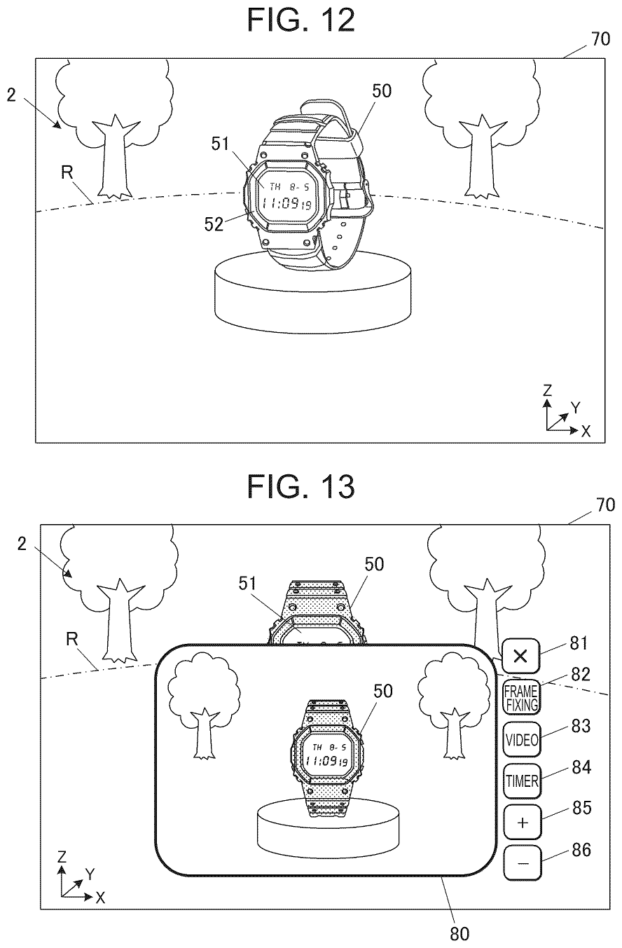

FIG. 12 is a diagram illustrating the VR screen 70 when the avatar 40 in operation is present within the reference range R.

FIG. 13 is a diagram illustrating the VR screen 70 when the avatar 40 activates the virtual camera application in the state of FIG. 12.

As illustrated in FIG. 13, a virtual shooting window 80 is displayed on the VR screen 70 when the virtual camera application is activated. The shooting window 80 displays a range of shooting in real time. The function of the shooting window 80 corresponds to the function of an LCD monitor for live-view shooting of a real camera. The user is able to adjust the shooting range in the shooting window 80 by adjusting the orientation of the VR headset 31 or the controller 32, or by performing a predetermined operation. In addition, the user is able to make the avatar 40 do the shooting by performing a predetermined shooting operation.

The data of the captured images are stored in the storage unit 23 of the control device 20.

An exit button 81, a frame fixing button 82, a video button 83, a timer button 84, a zoom-in button 85, and a zoom-out button 86 are displayed near the shooting window 80.

Selecting the exit button 81 enables the shooting window 80 to be cleared and the shooting operation to be terminated.

Selecting the frame fixing button 82 fixes the shooting range of the shooting window 80. It is also possible to take a commemorative photo or the like containing the avatar 40 in operation by moving the avatar 40 in operation to within the shooting range while the shooting range is fixed.

Selecting the movie button 83 causes a shift to the mode of taking a movie instead of a still image.

When the shooting operation is performed with the timer button 84 selected, a movie is taken after the predetermined timer time has elapsed since the shooting operation is performed.

Selecting the zoom-in and zoom-out buttons 85 and 86 enables the shooting range to be zoomed in and zoomed out, respectively, by the amount of adjustment corresponding to the number of times that the respective buttons are selected. Instead of the zoom-in and zoom-out buttons 85 and 86, a slider bar for zoom adjustment may be used.

When the virtual camera application is activated, it is determined that the avatar 40 is in shooting operation and the target avatar condition is satisfied. Therefore, in the situation illustrated in FIG. 13, the avatar 40 in operation that satisfies the target avatar condition is present within the reference range R. Thereby, the display settings S of the watch object 50 are adjusted based on the avatar information Ia of the avatar 40 in operation. The method of adjusting the display settings S is the same as in the above (i). For example, by starting the shooting operation from the state of FIG. 12, the “orientation” of the display settings S is adjusted so that the watch face 51 of the watch object 50 faces the avatar 40 in operation as illustrated in FIG. 13. In addition, since the avatar 40 in operation is in the shooting operation and the watch object 50 is placed outdoors, the application condition C of the appearance variation “V2” in the variation data 2331 of FIG. 5 is satisfied. Therefore, the “appearance variation” of the display settings S is changed to “V2,” which is reflected in the appearance of the watch object 50. The reflection of the appearance variation “V2” causes a change in the color of the bezel 52 to blue for the watch object 50 illustrated in FIG. 13. Furthermore, the colors of the band and other parts are also changed to blue according to the settings omitted in FIG. 5.

(Global display mode and local display mode)

In this embodiment, the watch object 50 on the VR screen 70 is displayed in either the global display mode or the local display mode.

The global display mode is a display mode in which a plurality (all) of avatars 40 is able to see the watch object 50 in a common display form. When adjusted in the global display mode, the display settings S of the watch object 50 are adjusted so that the display form of the watch object 50 seen by the plurality of avatars 40 is the same.

On the other hand, the local display mode is a display mode in which the display form of the watch object 50 may be different for each of the avatars 40. When adjusted in the local display mode, the display settings S of the watch object 50 are adjusted separately and independently for each of the avatars 40 on the basis of the relationship between each of the plurality of avatars 40 and the watch object 50.

Switching between the global display mode and the local display mode may also be performed according to the motion of an arbitrary avatar 40 (user).

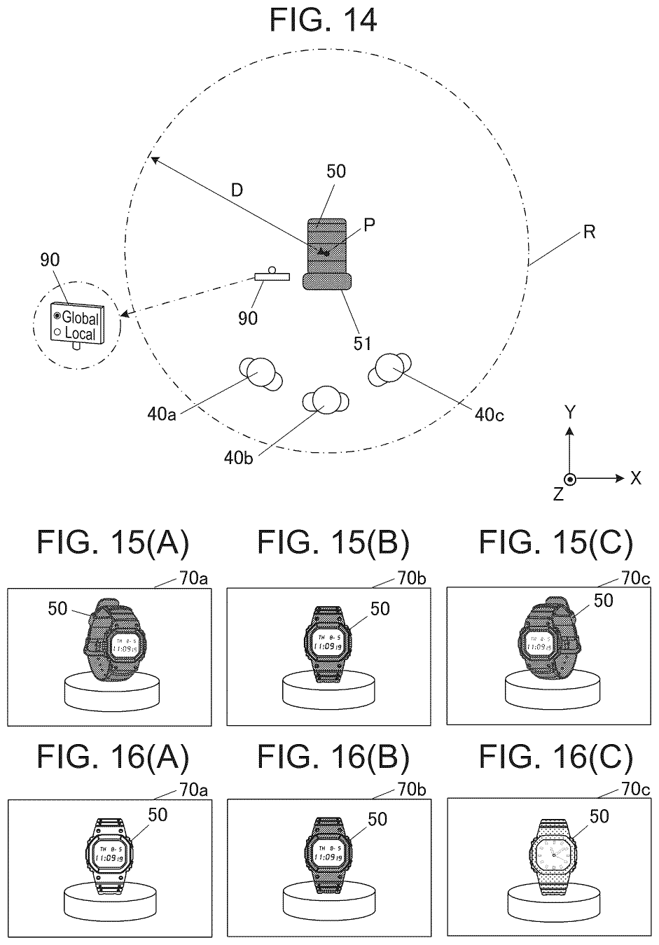

FIG. 14 is a diagram for describing how to switch between the global display mode and the local display mode.

In FIG. 14, it is assumed that three avatars 40a to 40c satisfying the target avatar condition are present within the reference range R. In addition, a switching object 90 for use in switching the display mode is installed near the watch object 50. Whenever the arbitrary avatar 40 performs a predetermined operation (for example, a motion to contact) on the switching object 90, the display mode is switched between the global display mode and the local display mode.

FIGS. 15A to 15C are diagrams illustrating an example of adjusting the display form in the global display mode.

FIG. 15A is a VR screen 70a corresponding to the avatar 40a of FIG. 14, FIG. 15B is a VR screen 70b corresponding to the avatar 40b, and FIG. 15C is a VR screen 70c corresponding to the avatar 40c. Thus, in the global display mode, there is displayed an image of the watch object 50, having the common-adjusted display settings S (the “orientation” and the “appearance variation”), seen from the position of each avatar 40 in the VR screen 70 corresponding to each avatar 40.

FIGS. 16A to 16C are diagrams illustrating an example of adjusting the display form in the local display mode.

FIGS. 16A to 16C are also VR screens 70a to 70c corresponding to the avatars 40a to 40c of FIG. 14, respectively. Thus, in the local display mode, there is displayed an image of the watch object 50, having the display settings S (the “orientation” and the “appearance variation”) adjusted separately and independently according to the avatar information Ia of each avatar 40, seen from the position of each avatar 40 in the VR screen 70 corresponding to each avatar 40. Specifically, the “orientation” of the display settings S is adjusted so that the watch face 51 faces each avatar 40 from the viewpoint of each avatar 40. In addition, the application condition C satisfied for each avatar 40 is identified, and the “appearance variation” corresponding to the application condition C is selected and reflected in the display settings S. For example, the appearance variation “V2” is selected in the VR screen 70a corresponding to the avatar 40a, the appearance variation “V4” is selected in the VR screen 70b corresponding to the avatar 40b, and the appearance variation “V3” is selected in the VR screen 70c corresponding to the avatar 40c.

Switching between the global display mode and the local display mode is not limited to a predetermined operation on the switching object 90. For example, when a distance between the position of the avatar 40a in FIG. 14 and the position of the avatar 40b at the closest position to the avatar 40a is within a predetermined distance, it is determined that the avatar 40a and the avatar 40b are in the same group, and the VR screens 70a and 70b corresponding to the avatars 40a and 40b are automatically displayed in the global display mode. Similarly, when a distance between the position of the avatar 40b and the position of the avatar 40c at the closest position to the avatar 40b is within a predetermined distance, it is determined that the avatar 40a to 40c are in the same group, and the VR screens 70a to 70c corresponding to the avatars 40a to 40c are automatically displayed in the global display mode. This enables taking a commemorative photo efficiently when the plurality of avatars 40 is gathered in relatively close positions in the virtual space 2, by considering the avatars 40 that are present nearby as one (the same) group and displaying each group in the global display mode.

(Object display processing)

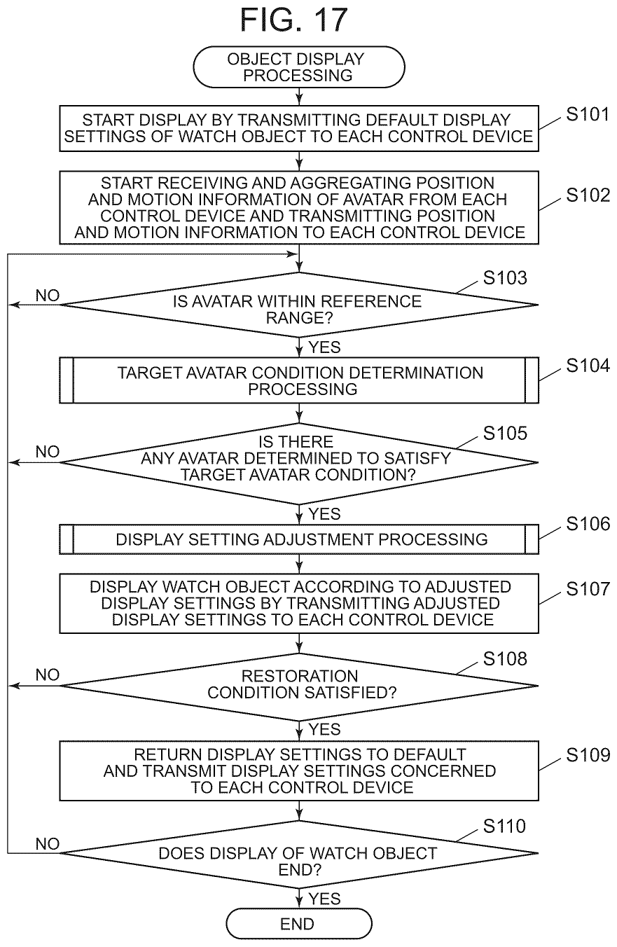

The following describes object display processing performed by the information processing system 1 to implement the above operation. Hereinafter, the process performed by the CPU 11 of the server 10 in the object display processing is focused on for the description. FIG. 17 is a flowchart illustrating a control procedure for the object display processing.

The object display processing is performed when a VR service is started for at least one user.

When the object display processing is started, the CPU 11 of the server 10 sets the display settings S of the watch object 50 in the object data 133 to the default settings (for example, a default “orientation” and the “appearance variation” of the “default 1”) and transmits the display settings S to each control device 20. This causes the CPU 11 to start displaying the watch object 50 on the VR headset 31 with the default display settings S (step S101). In addition, the CPU 11 starts receiving and aggregating the position and motion information Ib of the avatar 40 from each control device 20, and then transmitting the position and motion information Ib to each control device 20 (step S102).

The CPU 11 repeatedly determines whether the avatar 40 is present within the reference range R centered at the object position P of the watch object 50 (step S103), and when the avatar 40 is determined to be present within the reference range R (“YES” in step S103), the target avatar condition determination processing is performed (step S104).

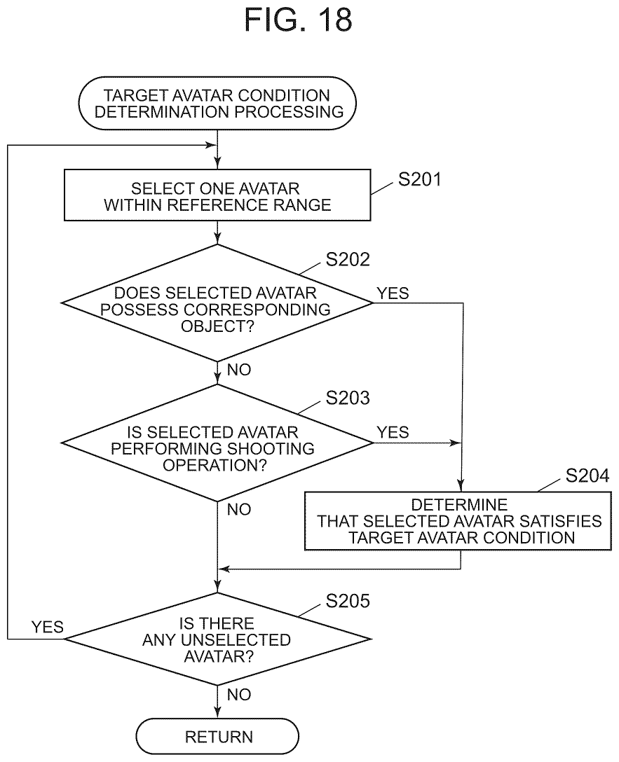

FIG. 18 is a flowchart illustrating a control procedure for the target avatar condition determination processing.

When the target avatar condition determination processing is invoked, the CPU 11 selects one avatar 40 within the reference range R (step S201). The CPU 11 refers to the avatar data 132 and determines whether the selected avatar 40 possesses a corresponding object (step S202). When determining that the selected avatar 40 possesses the corresponding object (“YES” in step S202), the CPU 11 determines that the selected avatar 40 satisfies the target avatar condition (step S204).

When determining that the selected avatar 40 does not possess the corresponding object (“NO” in step S202), the CPU 11 refers to the latest position and motion information Ib of the avatar data 132 and determines whether the selected avatar 40 is performing a shooting operation (step S203). When determining that the selected avatar 40 is performing the shooting operation (“YES” in step S203), the CPU 11 determines that the selected avatar 40 satisfies the target avatar condition (step S204).

When determining that the selected avatar 40 is not performing the shooting operation (“NO” in step S203), or when step S204 is completed, the CPU 11 determines whether there is an unselected avatar 40 (step S205). When determining that there is an unselected avatar 40 (“YES” in step S205), the CPU 11 returns the processing to step S201. When determining that there is no unselected avatar 40, the CPU 11 terminates the target avatar condition determination processing and returns the processing to the object display processing of FIG. 17.

Returning to FIG. 17, the CPU 11 determines whether there is an avatar that is determined to satisfy the target avatar condition in the target avatar condition determination processing (step S105). When determining that there is no avatar that is determined to satisfy the target avatar condition (“NO” in step S105), the CPU 11 returns the processing to step S103. When determining that there is an avatar that is determined to satisfy the target avatar condition (“YES” in step S105), the CPU 11 performs display setting adjustment processing (step S106).

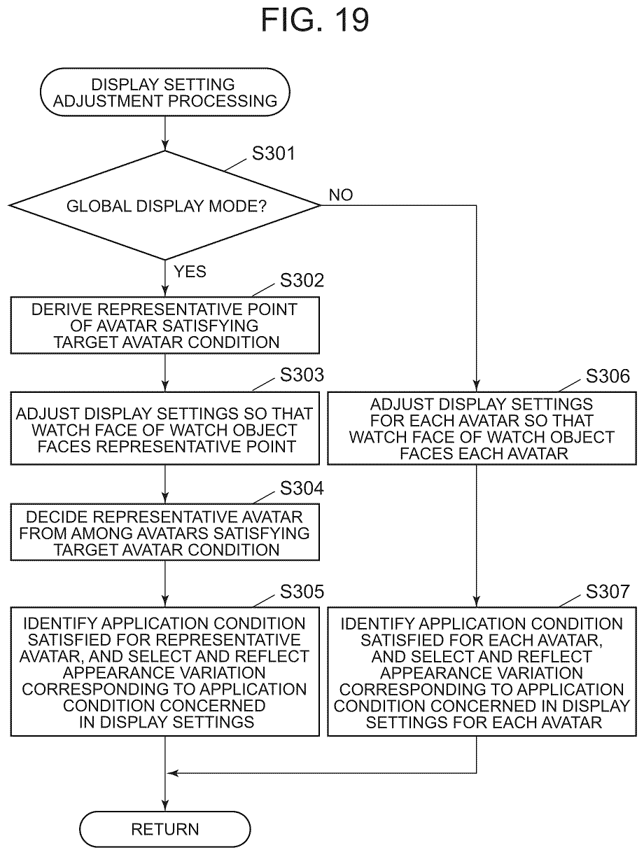

FIG. 19 is a flowchart illustrating a control procedure for display setting adjustment processing.

When the display setting adjustment processing is invoked, the CPU 11 determines whether the current display mode is the global display mode (step S301).

When determining that the current display mode is the global display mode (“YES” in step S301), the CPU 11 derives the representative point Q of the avatar 40 that satisfies the target avatar condition (step S302). When there is only one avatar 40 that satisfies the target avatar condition, the avatar position of the avatar 40 is considered as the representative point Q. The CPU 11 adjusts the “orientation” of the display settings S in the object data 133 so that the watch face 51 of the watch object 50 faces the representative point Q (step S303).

The CPU 11 decides the representative avatar from among the avatars 40 satisfying the target avatar condition (step S304). When only one of the avatars 40 satisfies the target avatar condition, the avatar 40 is selected as the representative avatar. The CPU 11 identifies the application condition C that is satisfied for the representative avatar on the basis of the avatar information Ia of the representative avatar, selects the “appearance variation” corresponding to the application condition C, and reflects the “appearance variation” in the display settings S of the object data 133 (step S305).

When determining in step S301 that the display mode is not the global display mode (is the local display mode) (“NO” in step S301), the CPU 11 adjusts the “orientation” of the display settings S of the object data 133 for each avatar 40 so that the watch face 51 of the watch object 50 faces each avatar 40 (step S306). In this specification, the CPU 11 keeps the adjusted display settings S in the object data 133 for each avatar 40. Alternatively, a plurality of object data 133 corresponding to the plurality of avatars 40 may be generated, and the contents of the display settings S in each of the object data 133 may be changed for each avatar 40.

The CPU 11 identifies the application condition C to be satisfied for each avatar 40 on the basis of the avatar information Ia of each avatar 40, selects the “appearance variation” corresponding to the application condition C, and reflects the selected “appearance variation” in the display settings S for each avatar 40 (the possessed display settings S in the above or the display settings S in the plurality of object data 133) (step S307).

When step S305 or S307 is completed, the CPU 11 terminates the display setting adjustment processing and returns the processing to the object display processing of FIG. 17.

Returning to FIG. 17, the CPU 11 displays the watch object 50 on the VR headset 31 according to the adjusted display settings S by transmitting the adjusted display settings S to each control device 20 (step S107). Specifically, in the case of the global display mode, the CPU 11 transmits the common display settings S to each control device 20, so that the watch object 50 is displayed in the common display form according to the display settings S. In the case of the local display mode, the CPU 11 transmits the display settings S adjusted for each avatar 40 to each control device 20, so that the watch objects 50 are displayed in the display forms different from each other.

The CPU 11 determines whether the restoration condition described above is satisfied (step S108). When determining that the restoration condition is not satisfied (“NO” in step S108), the CPU 11 returns the processing to step S103. When determining that the restoration condition is satisfied (“YES” in step S108), the CPU 11 returns the display settings S to the default and transmits the display settings S to each control device 20 (step S109). This causes each VR headset 31 to display the watch object 50 in the default display form.

The CPU 11 determines whether the display of the watch object 50 ends (for example, the VR service ends) (step S110). When determining that the display of the watch object 50 continues (“NO” in step S110), the CPU 11 returns the processing to step S103. When determining that the display of the watch object 50 ends (“YES” in step S110), the CPU 11 terminates the object display processing.

### (Variation 1)

The following describes variation 1 of the above embodiment. In the following, the differences from the above embodiment are described, and the description of characteristics common to the above embodiment are omitted.

The location of the watch object 50 in the virtual space 2 may be able to be changed, for example, by being transported by the avatar 40. In the case where the location of the watch object 50 in the virtual space 2 is changed, the display settings S are adjusted so that the display form of the watch object 50 becomes the display form appropriate for the changed location. For example, in the case where the watch object 50 is moved indoors by the avatar 40a from the situation illustrated in FIG. 9, the avatar 40a possesses the corresponding object and the watch object 50 is placed indoors, and thus the application condition C of the appearance variation “V5” in the variation data 2331 of FIG. 5 is satisfied. Therefore, the appearance variation is changed from “V1” to “V5,” which is reflected in the display of the watch object 50. The “location” of the application condition C is not limited to “outdoors” and “indoors,” but may be a specific area, a specific facility, or the like in the virtual space 2.

(Variation 2)

The following describes variation 2 of the above embodiment. In the following, the differences from the above embodiment is described, and the description of characteristics common to the above embodiment are omitted. Variation 2 may be combined with variation 1.

When the distance between the watch object 50 and the avatar 40 satisfying the target avatar condition is greater than or equal to the reference distance, the display settings S may be adjusted so that the watch object 50 displays the analog time. The reference distance may be the distance D, which is the radius of the reference range R, or may be different from the distance D. This allows the analog time display to be easily visible from a distance when the avatar 40 is more than or equal to the reference distance away from the watch object 50. When the reference distance is the distance D, the operation of this variation is able to be implemented by setting the “time display system” of “default 1” and “default 2” in the variation data 2331 of FIG. 5 to “analog.”

When the distance between the watch object 50 and the avatar 40 is less than the reference distance, the display settings S are adjusted based on the avatar information Ia as described in the above embodiment. Therefore, when the “time display system” of the selected appearance variation is “digital,” the time display is changed to the digital time display.

### Advantageous Effect

Objects placed in a virtual space constructed by a conventional computer each have a predefined display form, thereby causing a problem that the expressions of the objects in the virtual space are monotonous.

In contrast, in the information processing method of the present embodiment, the CPU 11 adjusts the display settings S according to the display form of the watch object 50 in the virtual space 2 on the basis of the avatar information la on the avatar 40 in the case where the avatar 40 satisfying the target avatar condition is located within the reference range R including the object position P in the virtual space 2 in which the watch object 50 is placed.

This automatically changes the display form of the watch object 50 when the avatar 40 satisfying the target avatar condition is in the vicinity of the watch object 50, thereby enabling more diverse expressions using the watch object 50.

Furthermore, in addition to the avatar 40 being within the reference range R, the target avatar condition needs to be satisfied, thereby reducing the occurrence of the problem of causing a change in the display form of the clock object 50 more frequently than necessary that causes discomfort to the user.

Moreover, it is possible to make the user recognize the watch object 50 as a display object more effectively and efficiently under the limitation of data volume and so on. For example, it is possible to display substantially a plurality of watch objects 50 in a limited space. Moreover, compared to the case where a plurality of watch objects 50 with different display forms are displayed side by side, the load on each device of the information processing system 1 is able to be reduced by reducing the drawing processing.

In addition, the target avatar condition is satisfied when the avatar 40 possesses a predetermined corresponding object corresponding to the watch object 50. This provides a user experience in which the display form of the watch object 50 changes triggered by the possession of the corresponding object. In addition, it enables an increase in the value of the corresponding object in the virtual space 2, thereby, for example, enabling the promotion of the sales of the corresponding object.

The target avatar condition is satisfied when the avatar 40 is performing a shooting operation to shoot the virtual space 2. This allows the watch object 50 to automatically face the photographer. As a result, it becomes easy to take a commemorative photo or the like in the virtual space 2 and to shoot the watch object 50 from an ideal angle.

In addition, based on the position of the avatar 40 identified from the avatar information Ia, the CPU 11 adjusts the “orientation” of the display settings S of the watch object 50 so that the watch face 51 of the watch object 50 faces the avatar 40. This enables the watch face 51 to be easily visible to the avatar 40 that satisfies the target avatar condition.

In addition, the CPU 11 adjusts the “orientation” of the display settings S of the watch object 50 so that the watch face 51 of the watch object 50 faces the representative point Q of the plurality of avatars 40 in the case where the plurality of avatars 40 satisfying the target avatar condition is located within the reference range R. This enables the plurality of avatars 40 satisfying the target avatar condition to easily see the watch face 51.

Moreover, the avatar information Ia includes information on at least one of the appearance, attribute, and possessed object of the avatar 40, and the CPU 11 adjusts the “appearance variation” of the display settings S so that the watch object 50 is displayed in a display form according to at least one of the appearance, attribute, and possessed object of the avatar 40. This enables the appearance of the watch object 50 to be changed flexibly and appropriately according to the characteristics of the avatar 40.

Adjustment of the display settings S also includes deciding the appearance variation of the watch object 50 to be displayed by selecting from among the preregistered multiple types of appearance variations that differ from each other. This enables the appearance of the watch object 50 to be adjusted appropriately by a simple process of selecting the appearance variation.

In addition, making the watch object 50 the target of the display form adjustment, for example, enables the user to effectively recognize the watch on which the watch object 50 is modeled.

After adjusting the display settings S, the CPU 11 returns the display settings S to the state before the adjustment (default state) when a predetermined restoration condition is satisfied. This enables the display settings S to be automatically restored to the default state after any necessary display form adjustment has been performed.

Furthermore, the CPU 11 displays the watch object 50 in the global display mode, in which the display settings S are adjusted so that the display forms of the watch object 50 seen from the plurality of avatars 40 are the same, or in the local display mode, in which the display settings S of the watch object 50 are adjusted separately and independently for each of the plurality of avatars 40 on the basis of the relationship between each of the avatars 40 and the watch object 50, and then switches between the global display mode and the local display mode according to the operation of the avatar 40 on the switching object 90 provided in the virtual space 2. This enables the watch object 50 to be easily displayed in the display mode desired by the user.

Since the information processing system 1 of this embodiment and the server 10 as an information processing device are equipped with the CPU 11 described above, more diverse expressions using the watch object 50 may be allowed.

Moreover, the program 131 of this embodiment causes the CPU 11 to perform a process of adjusting the display settings S according to the display form of the watch object 50 in the virtual space 2 on the basis of the avatar information la on the avatar 40 when the avatar 40 satisfying the target avatar condition is located within the reference range R including the object position P in the virtual space 2 where the watch object 50 is placed.

This enables more diverse expressions using the watch object 50.

In the information processing method of this embodiment, the CPU 311 of the VR device 30, which includes the display unit 315, and the operation input unit 314 as an input unit, the sensor unit 317, the controller 32, and the operation input unit 324, displays the watch object 50 in the virtual space 2 on the display unit 315 on the basis of the display settings S according to the display form of the watch object 50 in the virtual space 2, and the display settings S are adjusted on the basis of the avatar information la for the avatar 40 when the avatar 40 satisfying the target avatar condition is located within the reference range R including the object position P in the virtual space 2. This enables more diverse expressions using the watch object 50.

### (Others)

The description in the above embodiment is merely an example of the information processing method, the information processing system, and the recording medium related to this disclosure, and is not limited thereto.

For example, the server 10 adjusts the display settings S of the watch object 50 in the above embodiment as an example, but alternatively, the control device 20 may adjust the display settings S. In this case, the control device 20 corresponds to the “information processing device” and the CPU 21 corresponds to the “processing unit.”

In other words, in the global display mode, the respective control devices 20 receive the same data that represents the status of the avatars 40 around the watch object 50 from the server 10. Then, the respective control devices 20 adjust the common display settings S in the same way as the server 10 did in the above embodiment, and reflects the adjustment in the display of the watch object 50.

In the local display mode, each control device 20 changes the display settings S independently on the basis of the relationship between the avatar 40 corresponding to the user of the control device 20 and the watch object 50, and reflects the change in the display of the watch object 50.

Furthermore, the VR device 30 may also adjust the display settings S. In this case, the VR device 30 corresponds to the “information processing device” and the CPU 311 corresponds to the “processing unit.”

Adjustment of the display form is not limited to adjustment of the “orientation” and the “appearance variation.” For example, in the case where the virtual space 2 satisfies a predetermined darkness condition (evening, nighttime, or the like) when an avatar 40 satisfying the target avatar condition is present within the reference range R, the display form may be adjusted so that the watch face 51 of the watch object 50 is illuminated by LEDs or a backlight.

The object for which the display form is to be adjusted is not limited to the watch object 50, but the display form may be adjusted for arbitrary objects (for example, a piano, a calculator, and the like) placed in the virtual space 2 in the same way as in the above embodiment.

The application condition C in the object data 233 is not limited to the condition illustrated in FIG. 5. For example, the “avatar” condition of the application condition C may be a distance from the watch object 50 to the avatar 40. By associating different appearance variations with the distance ranges different from each other, it becomes possible to produce a change in the appearance of the watch object 50 according to the movement of the avatar 40 approaching or moving away from the watch object 50.

Moreover, the adjustment of the “orientation” in the display settings S may be omitted and then the “avatar” condition of the application condition C may be changed to the angle of the position of the avatar 40 from the front direction of the watch object 50 (the direction in which the watch face 51 is facing). By associating different appearance variations with the angular ranges different from each other, it becomes possible to produce a change in the appearance of the watch object 50 according to the movement of the avatar 40 rotating around the watch object 50.

Although the application condition C is a combination of the condition for the “avatar” and the condition for the “location” in FIG. 5, the application condition C is not limited thereto, but may be only the condition for the “avatar” by omitting the condition for the “location,” for example.

Moreover, the target avatar condition is not limited to the condition satisfied in the case (i) where the target avatar possesses the corresponding object or the case (ii) where the target avatar is performing a shooting operation. For example, the target avatar condition may be satisfied in the case where the avatar 40 has a predetermined attribute or in the case where the watch object 50 has a predetermined appearance. In addition, the target avatar condition may be satisfied in the case where the avatar 40 is taking a video or in the case where the taken video is being distributed in real time, in other words, in the case where an online distribution event is being performed.

Moreover, a user may operate the avatar 40 without wearing the VR headset 31. In this case, an image of the virtual space 2 is displayed on a normal display (for example, a liquid crystal display or the like included in the output unit 25 of the control device 20) provided at a position visible to the user, instead of the VR headset 31. The screen displayed in this case may be the VR screen 70 when the VR device 30 is able to detect user's movements. In addition, a third-person viewpoint screen may be displayed, instead of the VR screen 70. For example, the user may operate the controller 32 to cause the avatar 40 to behave in the virtual space 2 from the third-person viewpoint.

Moreover, the functions of the control device 20 may be integrated into the VR device 30 (for example, the VR headset 31) with the control device 20 omitted.

Furthermore, the functions of the control device 20 may be integrated into the server 10 with the control device 20 omitted, so that the server 10 and the VR device 30 perform the VR services. In this case, signals output from the operation input unit 324 and the sensor unit 325 of the VR device 30 are transmitted to the communication unit 14 of the server 10 via the communication unit 326. The server 10 controls the motion of the avatar 40 in the virtual space 2 according to the received user operation. In other words, the server 10 performs the same processing as the control device 20 described above, generates image data of the virtual space 2, and transmits the image data to the VR device 30.

Although the above description has disclosed an example of using the HDD and

SDD of the storage units 13 and 23 as computer-readable media for a program of this disclosure, the present disclosure is not limited to this example. As other computer-readable media, information recording media such as a flash memory, a CD-ROM, and the like may be applied. In addition, a carrier wave is also applicable to the present disclosure as a medium for providing data of the program according to the present disclosure via communication lines. Furthermore, naturally the detailed configuration and operation of each component of the information processing system 1 in the above embodiments may be modified as necessary without departing from the gist of the present disclosure.

Although the embodiments of the present disclosure have been described, the scope of this disclosure is not limited to the embodiments described above, but includes the scope of the disclosure described in the claims and their equivalents.

What is claimed is:

1. An information processing method performed by an information processing device including a memory that stores a program and at least one processor that executes the program,
wherein the processor adjusts settings related to a display form of an object in a virtual space, based on avatar information on an avatar, when the avatar satisfying a predetermined condition is located within a reference range including a location of the object in the virtual space in which the object is placed.

2. The information processing method according to claim 1, wherein the processor determines that the predetermined condition is satisfied when the avatar possesses a predetermined corresponding object that corresponds to the object.

3. The information processing method according to claim 1, wherein the processor determines that the predetermined condition is satisfied when the avatar is performing a shooting operation to capture the virtual space.

4. The information processing method according to claim 1, wherein the processor adjusts the settings for an orientation as the display form of the object, based on the position of the avatar identified according to the avatar information, so that a predetermined region of the object faces the avatar.

5. The information processing method according to claim 1, wherein the processor adjusts the settings for the orientation as the display form of the object, so that the predetermined region of the object faces a representative point of a plurality of avatars, each avatar identical to the avatar, when the plurality of avatars satisfying the predetermined condition is located within the reference range.

6. The information processing method according to claim 1, wherein:
the avatar information includes information on at least one of an appearance, an attribute, and a possessed object of the avatar; and
the processor adjusts the settings so that the object is displayed in the display form according to at least one of the appearance, the attribute, and the possessed object of the avatar.

7. The information processing method according to claim 1, wherein the processor selects and decides the appearance of the object to be displayed among from the preregistered multiple types of appearances that differ from each other in the adjustment of the settings.

8. The information processing method according to claim 1, wherein the processor adjusts the settings so that the display form of the object is a display form corresponding to a changed location when the location of the object in the virtual space is changed.

9. The information processing method according to claim 1, wherein the object is a watch object.

10. The information processing method according to claim 9, wherein the processor adjusts the settings so that the object displays analog time when the distance between the object and the avatar is greater than or equal to a reference distance.

11. The information processing method according to claim 1, wherein the processor returns the settings to a state before the adjustment when a predetermined restoration condition is satisfied after the settings are adjusted.

12. The information processing method according to claim 1, wherein the processor displays the object in a global display mode, in which the settings are adjusted so that the display forms of the object seen from the plurality of avatars are the same, or in a local display mode, in which the settings related to the display form of the object are adjusted separately and independently for each of the plurality of avatars, based on the relationship between each of the plurality of avatars and the object, and switches between the global display mode and the local display mode according to the operation of the avatar on a switching object provided in the virtual space.

13. An information processing system, comprising:
an information processing device including a first communication circuit, a first memory that stores a first program, and at least one first processor that executes the first program; and
a terminal device including a display, a second communication circuit, a second memory that stores a second program, and at least one second processor that executes the second program,
wherein the first processor causes information on a virtual space in which an object is placed to be transmitted by the first communication circuit;
wherein the second processor displays the virtual space on the display, based on the information on the virtual space in which the object received via the second communication circuit is placed;
wherein the first processor adjusts settings related to a display form of the object in the virtual space, based on avatar information on an avatar, when the avatar satisfying a predetermined condition is located within a reference range including a location of the object in the virtual space in which the object is placed;
wherein the first processor causes the first communication circuit to transmit the settings related to the display form of the object after the adjustment; and
wherein the second processor causes the display to display the object, based on the settings related to the display form of the object after the adjustment received via the second communication circuit.

14. An information processing device comprising a processing unit, wherein the processing unit adjusts settings related to a display form of an object in a virtual space, based on avatar information on an avatar, when the avatar satisfying a predetermined condition is located within a reference range including a location of the object in the virtual space in which the object is placed.

15. A computer-readable recording medium that records a program for causing a computer to perform processing of adjusting settings related to a display form of an object in a virtual space, based on avatar information on an avatar, when the avatar satisfying a predetermined condition is located within a reference range including a location of the object in the virtual space in which the object is placed.
